(19) United States
(12) Patent Application Publication
(10) Pub. No.: US 2025/0341449 A1
(43) Pub. Date: Nov. 6, 2025

(54) A SAMPLING APPARATUS AND A CYCLONE

(71) Applicant: Tribe Technology Pty Ltd, Perth (AU)

(72) Inventors: Greg Gardiner, Perth (AU); Sirish Gorijala, Perth (AU); Michael Kapfer, Perth (AU)

(73) Assignee: Tribe Technology Pty Ltd, Perth (AU)

(21) Appl. No.: 18/854,228

(22) PCT Filed: Apr. 4, 2023
(86) PCT No.: PCT/AU2023/050268

§ 371 Date: Oct. 4, 2024

(30) Foreign Application Priority Data
Apr. 4, 2022 (AU) 2022900877

(51) Int. Cl. G01N 1/34

(52) U.S. Cl. CPC G01N 1/34

(57) ABSTRACT

The present invention provides a sampling apparatus (13) for use in extracting a sample from cuttings which are delivered to the sample apparatus (13) entrained in a gaseous stream. The apparatus (13) comprises a separation means to separate the cuttings from the gaseous stream and a sampling assembly (17) adapted to receive the cuttings from the separation means to allow samples to be taken therefrom. The separation means comprises a cyclone (11) to which the cuttings entrained in a gaseous stream is delivered. The cyclone (11) has an outlet (47) through which the cuttings pass from the cyclone, and a vent (27) through which the gaseous stream passes. The cyclone comprising an inner rotating body (33) wherein the body (33) is cleaned as it rotates.

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/AU2023/050268, filed on Apr. 4, 2023, designating the United States of America, which in turn claims the benefit of priority under 35 U.S.C. §§ 119, 365 of Australian Patent Application No. 2022900877, filed Apr. 4, 2022, the contents of which are relied upon and incorporated herein by reference in their entirety.

### FIELD OF THE DISCLOSURE

The present invention generally relates to a sampling apparatus. In particular the present invention relates to a cyclone used in the sampling apparatus whereby the cyclone is capable of self-cleaning.

### BACKGROUND

Drilling for geological samples is an important step in determining the location and feasibility of new sites for mining operations. Drilling is used in the mining industry to probe the contents of unknown and known ore deposits at potential sites.

A critical feature of assessing the feasibility of a potential mine site is the collection and analysis of geological samples. By withdrawing samples of rock and soil from specific depths, geologists can analyze the samples by chemical assay and conduct petrologic, structural, and mineralogical studies of the underground structures.

Drilling exploration is carried out to identify mineral resources with the view of identifying potential new mining sites. Drilling provides critical information for the evaluation of the mineral deposits in that area. Drilling is used to search for mineral occurrences or clues in the rocks that may lead to mineral deposits. Drilling penetrates deep into the ground and brings up samples. If there is any mineralization at given points far beneath the surface, samples taken while drilling can quantify its presence at that particular point, and/or can indicate whether additional drilling is required/worthwhile in that area.

Mineral exploration is typically carried out in remote, harsh conditions. A drill rig is usually transported to a site and a drill team is used to run and maintain the rig. Existing exploration drilling rigs require skilled operators, often working in difficult and hazardous conditions. Noting the remoteness of most drilling locations, the drill team needs to be self-sufficient and be able to keep the rig running, as well as be able to look after themselves. This requires provision of fuel, water, spare parts, shelter and the essentials to live, namely water and food.

Drilling in any environment is hazardous but mineral exploration in remote locations, presents significant risk factors. As a result, there is a desire to move towards autonomous exploration drilling rigs, requiring less direct manual intervention during operation.

Drill rigs can be set up for reverse-circulation drilling, rotary air blast drilling, wireline coring or open-hole boring. In reverse-circulation (RC) drilling, drill rods having two concentric tubes are used. Compressed air is supplied through the gap between the inner and outer tubes to act on a pneumatic reciprocating piston, known as a downhole hammer, comprising a drill bit with round protruding tungsten-carbide buttons that can cut hard rock. Drill cuttings are returned to the surface via the inner tube inside the drill rods.

At the surface, the cuttings are typically directed into a sampler. The sampler typically comprises a cyclone separator and a splitting device for dividing a sample from the cuttings. Samples of the cuttings are collected in order to later identify and/or assess the quality and quantity of the mineral the drill team are exploring. In light of the substantial costs associated with the establishment of a mine it is of significant importance that the samples taken are as true a representation of the drilled material as possible.

Typically the process of collecting samples involves passing a dirty gaseous stream (in which is entrained cuttings) through a cyclone separator. Generally the dirty gaseous stream enters tangentially near the top of the cyclone separator. As a result of the centrifugal forces, larger particles (cuttings) in the dirty gaseous stream are thrown to the sides of the cyclone separator and fall to the bottom, where they are collected or discharged through a bottom outlet. The remaining gas stream reverses direction and spirals up the center of the cyclone and out the top of the cyclone separator through a vortex finder.

As the gaseous stream circulates through the cyclone separator the cuttings fall to the bottom of the cyclone separator while the gaseous stream escapes from the top of the cyclone separator. A sample of the cuttings is then collected from a splitter at the cyclone's outlet. The splitter seeks to provide an evenly distributed sample from the cuttings. Collection is largely a manual process where sample bags are filled from the collected cuttings at regular intervals. One of the drilling team takes the sample bags from the bottom of the cyclone separator, labels it and sets it aside for later collection and analysis. Typically a sample bag is taken from either side of the splitter and is taken at intervals dictated by the drilling program.

Several devices have been created to improve the sample taken from the drilled material leaving the cyclone. These devices seek to ensure the sample is a fair representation of the geological characteristics of the ground being drilled. One common device to improve the accuracy of the sample taken is a cone splitter. This type of splitter incorporates a cone which is located adjacent the outlet of the cyclone. As the cuttings impact upon the cone it is spread into an annulus from which the sample is taken. This device relies on an ‘hour glass’ effect between the cyclone's outlet and the apex of the cone and is an area prone to blockages.

An alternate device has a rotating cone and a port extending through the cone through which the sample passes. This device clogs when sticky and/or bulky cuttings are encountered as the port becomes blocked. In order to clear the blockage the splitter is required to be disassembled and cleaned.

Typically drilling exploration is carried out in dry environments. This, along with the drilling process, results in significant dust and airborne dirt. One way this may be minimized is to add water to the drilling process such that the cuttings returned to the surface are wet. However, adding water to the process, or coming across sections of wet or damp earth, presents additional problems to the drill rig. In particular wet cuttings or clay based cuttings entering the system tend to clog the cyclone separator, the sampling assembly and the equipment downstream therefrom. This requires the drill team to clean the equipment and de-clog the material so that the equipment is able to run efficiently. This is time intensive and results in suspending the drilling process. In addition, when taking a sample, clogged material comprising material taken at different depths can dislodge and fall into the sampler and enter the sampling bag at random intervals. This can contaminate/bias the sample and is not a fair representation of the rock being drilled at that point where the sample is taken.

As the drill team is on site, de-clogging the sampler is an everyday task and is one the team are readily able to complete. However, a drill rig which operates autonomously must find an alternate solution to maintain the equipment in functioning order while still ensuring a quality sample. Without this ability the sampler will become clogged, return biased samples and eventually stop operating.

The preceding discussion of the background art is intended to facilitate an understanding of the present invention only. The discussion is not an acknowledgement or admission that any of the material referred to is or was part of the common general knowledge as at the priority date of the application.

### SUMMARY OF THE DISCLOSURE

It is an object of this invention to provide a cyclone which is capable of self-cleaning.

Throughout the specification the term ‘cuttings’ is used to describe material, which is caused to pass from a drilled hole, typically during the drilling process, into a sampling apparatus. These cuttings may be dry or wet and are typically delivered to the cyclone in a gaseous stream.

Throughout the specification the term ‘dirty gaseous stream’ or ‘dirty gas stream’ is used to describe a gaseous stream in which is entrained large particulates, such as cuttings. The dirty gaseous stream may also contain fluid, such as water.

Throughout the specification the term ‘gaseous stream’ or ‘gas stream’ is used to describe a gaseous stream after previously entrained large particulates, such as cuttings, have been removed. While the gaseous stream will have particulates removed therefore, it is to be understood that the gaseous stream may not be completely free of particulates, and may contain fines (finely crushed or powdered materials (e.g. crushed rock, coal, ore)). The gaseous stream may also contain fluid, such as water.

Throughout the specification the terms ‘cyclone’ and ‘cyclone separator’ are used interchangeably, and generally refer to a device for removing particulates from a gaseous or liquid stream through vortex separation.

The present invention provides a sampling apparatus for use in extracting a sample from cuttings which are delivered to the sample apparatus entrained in a gaseous stream, the apparatus comprises:
a separation means to separate the cuttings from the gaseous stream; and
a sampling assembly adapted to receive the cuttings from the separation means to allow samples to be taken therefrom,
wherein the separation means comprises:
a cyclone to which the cuttings entrained in a gaseous stream is delivered, the cyclone having an outlet through which the cuttings pass from the cyclone, and a vent through which the gaseous stream with the remaining portion of drilled material entrained therein pass; the cyclone comprising an inner rotating body wherein the body is cleaned as it rotates.

Preferably the rotating body is cleaned continuously as it rotates.

Preferably an inner surface of the rotating body of the cyclone is cleaned as it rotates.

The present invention further provides a sample apparatus for use in extracting a sample

from cuttings which are delivered to the sample apparatus entrained in a gaseous stream, the apparatus comprises:
a separation means to separate the drilled material from the gaseous stream,
a splitter assembly to mix the cuttings, wherein the cuttings exit the separation means and pass into the splitter assembly,
a sampling assembly adapted to receive the cuttings from the splitter assembly and cause samples to be taken therefrom,
the separation means comprises:
a cyclone to which the cuttings entrained in a gaseous stream is delivered, the cyclone having an outlet through which the cuttings pass from the cyclone, and a vent through which gaseous stream may pass; the cyclone comprising an inner rotating cyclone body wherein an inner surface of the body is cleaned as it rotates.

Preferably the inner surface of the rotating cyclone body is cleaned continuously.

The cyclone may comprise a conical lower section and a cylindrical upper section. The conical lower section incorporates the inner rotating body.

The cyclone may comprise a first cleaning assembly which can be selectively operated to clean an inner surface of the cylindrical upper section.

The vent may be in the form of a vortex finder comprising a sleeve which extends into the cyclone through a lid of the cyclone. The sleeve may be co-axial with the central axis of the cyclone.

The cyclone may comprise a second cleaning assembly which can be selectively operated to clean an outer surface of the sleeve of the vortex finder.

Preferably the first cleaning assembly and the second cleaning assembly are combined such that upon activation of the combined cleaning assembly the inner surface of the cylindrical upper section and the outer surface of the surface of the vortex finder are cleaned simultaneously.

The cyclone may comprise a third cleaning assembly wherein a cleaning fluid, such as water, is injected into the cyclone to clean one or more inner surfaces thereof. The third cleaning assembly may comprise a plurality of nozzles located in the lid of the cyclone.

The vortex finder may comprise a fines recovery apparatus wherein at least a portion of fine particulate material entrained in the gaseous stream is recovered and recirculated into the cyclone.

The present invention further provides a cyclone for removing particulates from a gas stream, the cyclone comprises:
a housing which is adapted to receive a dirty gaseous stream,
a cyclone body rotatably supported in the housing, wherein the dirty gas stream enters the cyclone body whereupon particulates are caused to fall to the bottom of the cyclone body and be discharged therefrom, while the gas stream is vented from the cyclone body.

The cyclone body may have a first end which has a larger diameter than a second end. The first end may be in fluid communication with an inlet through which the dirty gaseous stream enters the cyclone.

The inlet may be provided by the housing.

The cyclone may be adapted to be connected to a drilling rig such that during drilling the drill rig delivers the dirty gaseous stream. The cyclone may be removably secured to a drill rig.

The cyclone body may incorporate a conical lower section.

The cyclone body may be conical shaped.

The cyclone body may co-operate with an upper section of the housing to define a separator region in which the dirty gaseous stream is received.

The separator region may incorporate the inlet for receiving the dirty gaseous stream, an outlet through which the particulate exits the separator region and a vent through which the gaseous stream exits the separator region. With the exception of the inlet, outlet and vent the separator region is relatively sealed to minimize leakage from the cyclone.

The cyclone may incorporate a drive means, such as a motor, to rotate the cyclone body relative to the housing. The motor may drive the cyclone body at its first end. The rotational velocity of the cyclone body can be varied according to various parameters including: the drill penetration rate, the cycle rate (the inner surface of the rotating body will require cleaning at least once per sample interval), the type of drilled material and its consistency, water/moisture volume ratio in cuttings, hydraulic efficiency, vibration induction, prevention of bias (where specific speeds results in discharge bias).

The cyclone body may have a rotational speed range of 0-250 RPM. The speed may be determined/based on the above noted parameters.

The cyclone body may have a rotational speed range of 0-150 RPM. The speed may be determined/based on the above noted parameters.

The cyclone body may have a rotational speed range of 0-75 RPM. The speed may be determined/based on the above noted parameters.

Rotation velocity of the cyclone body may be slowed or stopped during specific drill rig events, such as rod change, maintenance.

Preferably a first seal arrangement seals the region between the first end of the cyclone body and the housing. This minimizes any leakage from the cyclone body and the cyclone.

Preferably a second seal arrangement seals the region between the second end of the cyclone body and the housing. This minimizes any leakage in the cyclone.

The second end of the cyclone body may have an outlet therein which also provides the outlet of the separator region and the cyclone.

The cyclone may have at least one cleaning element which is fixed relative to an inner surface of the cyclone body. The at least one fixed cleaning element has an edge which is adjacent the inner surface of the cyclone body. The edge of the at least one cleaning element is sufficiently spaced from the inner surface of the cyclone body such that the cyclone is free to rotate. The edge of the at least one cleaning element is sufficiently spaced from the inner surface of the cyclone body such that any material attached to the inner surface of the cyclone body is removed. The at least one cleaning element may be in the form of a scraper. The scraper may continuously clean the inner surface of the cyclone body as it rotates.

The at least one cleaning element may follow the contour of the inner surface of the cyclone body. Where the contour is flat, the at least one cleaning element is elongate. Where the contour has a number of flat sections angular spaced to each other, the at least one cleaning element is in the form of a series of elongate elements connected in an end to end fashion such that the series of elongate elements mirrors the contour of the inner surface.

The cyclone may be in fluid communication with a splitter assembly wherein particulate exiting the cyclone body enters the splitter assembly.

The cyclone may be in fluid communication with a sampling assembly wherein particulate exiting the cyclone body enters the sampling assembly.

The cyclone may be in fluid communication with a splitter assembly wherein particulate exiting the cyclone body enters the splitter assembly, the splitter assembly providing a means to take samples from the cuttings leaving the splitter assembly.

The present invention further provides a cyclone for removing particulates from a dirty gas stream and discharging a gas stream therefrom, the cyclone comprises:
a cyclone body to receive the dirty gaseous stream, wherein the dirty gas stream enters the cyclone body whereupon particulates are caused to fall to the bottom of the cyclone body to be discharged therefrom, while the gas stream is vented from the cyclone body and the cyclone through a vortex finder which provides the outlet from the cyclone; the cyclone body is rotatably mounted wherein an inner surface of the cyclone body is cleaned as it rotates;
the vortex finder comprises a fines recovery apparatus wherein at least a portion of fine particulate material entrained in the gas stream is recovered and recirculated into the cyclone body.

The present invention further provides a cyclone for removing particulates from a dirty gas stream and discharging a gas stream therefrom, the cyclone comprises:
a cyclone body to receive the dirty gaseous stream, wherein the dirty gas stream enters the cyclone body whereupon particulates are caused to fall to the bottom of the cyclone body to be discharged therefrom, while the gas stream is vented from the cyclone body and the cyclone through a vortex finder which provides the outlet from the cyclone;
the vortex finder comprises a fines recovery apparatus wherein at least a portion of fine particulate material entrained in the gas stream is recovered and recirculated into the cyclone body.

The fines recovery apparatus may be incorporated in a first end portion of the vortex finder, the first end portion being adjacent the cyclone body.

The fines recovery apparatus may comprise a deflector assembly to deflect the gas stream entering the first end portion of the vortex finder towards an inner surface thereof.

The deflector assembly may comprise a first deflector wherein the first deflector deflects the gas stream entering the first end portion of the vortex finder towards an inner surface thereof. Preferably the first defector comprises a set of turbine blades.

The deflector assembly may comprise a second deflector. The second deflector may be mounted in series with the first deflector. Preferably the second defector comprises a set of turbine blades wherein the set of turbine blades of the first deflector are staggered relative to the set of turbine blades of the second deflector.

The fines recovery apparatus may comprise an inner sleeve co-axially mounted inward of a first end of the vortex finder. The inner sleeve may have a smaller outer diameter than the inner diameter of the first end portion of the vortex finder. A first end of the inner sleeve may be inwardly spaced from the deflector assembly.

A second end of the inner sleeve may have an outwardly projecting flange.

Preferably the outer surface of the inner sleeve, the inner surface of the first end portion of the vortex finder and the flange co-operate to define an annular sleeve having an open end and a closed end, wherein the open end allows the fine particulate material to enter the annular sleeve.

The vortex finder provides at least one port in the form of an opening extending through a wall of the annular sleeve of the fines recovery apparatus. The at least one port allows the fine particulate material to exit the annular sleeve and re-enter the cyclone body.

The fines recovery apparatus comprises a hood secured to the inner surface of the first end portion of the vortex finder adjacent the at least one port, wherein the hood collects and directs the fine particulate material from the annular sleeve through the at least one port.

The fines recovery apparatus deflects the gas stream leaving the cyclone body to swirl around the first end portion of the vortex finder, engaging with the inner surface thereof and exiting through the exit port to return to the cyclone body. This minimizes the volume of the sample which may escape the cyclone through the vortex finder, leading to a more accurate representation of the sample.

The cyclone may comprise a housing in which the cyclone body is rotatably mounted.

The cyclone body may have a first end which has a larger diameter than a second end. The first end may be in fluid communication with an inlet through which the dirty gaseous stream enters the cyclone.

The inlet may be provided by the housing.

The cyclone body may incorporate a conical lower section.

The cyclone body may be conical shaped.

The cyclone body may co-operate with an upper section of the housing to define a separator region in which the dirty gaseous stream is received.

The separator region may incorporate the inlet for receiving the dirty gaseous stream, an outlet through which the particulate exits the separator region and a vent through which the gaseous stream exits the separator region. With the exception of the inlet, outlet and vent the separator region is relatively sealed to minimize leakage from the cyclone.

The cyclone may incorporate a drive means, such as a motor, to rotate the cyclone body relative to the housing. The motor may drive the cyclone body at its first end. The rotational velocity of the cyclone body can be varied according to various parameters including: the drill penetration rate, the cycle rate (the inner surface of the rotating body will require cleaning at least once per sample interval), material type and consistency, water/moisture volume ratio in cuttings, hydraulic efficiency, vibration induction, prevention of bias (where specific speeds results in discharge bias).

Preferably the cyclone body is rotatably mounted wherein an inner surface of the cyclone body is cleaned as it rotates

The cyclone may comprise a conical lower section and a cylindrical upper section. The conical lower section incorporates the rotating cyclone body.

The cyclone may comprise a first cleaning assembly which can be selectively operated to clean an inner surface of the cylindrical upper section.

The vent may be in the form of a vortex finder comprising a sleeve which extends into the cyclone through a lid of the cyclone. The sleeve may be co-axial with the central axis of the cyclone.

The cyclone may comprise a second cleaning assembly which can be selectively operated to clean an outer surface of the sleeve of the vortex finder.

Preferably the first cleaning assembly and the second cleaning assembly are combined such that upon activation of the combined cleaning assembly the inner surface of the cylindrical upper section and the outer surface of the surface of the vortex finder are cleaned simultaneously.

The cyclone may comprise a third cleaning assembly wherein a cleaning fluid, such as water, is injected into the cyclone to clean one or more inner surfaces thereof. The third cleaning assembly may comprise a plurality of nozzles located in the lid of the cyclone.

The present invention further provides a cyclone for removing particulates from a dirty gas stream and discharging a gas stream therefrom, the cyclone comprises:
a cyclone body to receive the dirty gaseous stream, wherein the dirty gas stream enters the cyclone body whereupon particulates are caused to fall to the bottom of the cyclone body to be discharged therefrom, while the gas stream is vented from the cyclone body and the cyclone through a vortex finder which provides the outlet from the cyclone; a conical lower section and a cylindrical upper section, wherein the conical lower section incorporates the rotating cyclone body;
a first cleaning assembly which can be selectively operated to clean an inner surface of the cylindrical upper section.

Preferably the cyclone further provides a second cleaning assembly which can be selectively operated to clean an outer surface of the sleeve of the vortex finder.

The present invention further provides a cyclone for removing particulates from a dirty gas stream and discharging a gas stream therefrom, the cyclone comprises:
a cyclone body to receive the dirty gaseous stream, wherein the dirty gas stream enters the cyclone body whereupon particulates are caused to fall to the bottom of the cyclone body to be discharged therefrom, while the gas stream is vented from the cyclone body and the cyclone through a vortex finder which provides the outlet from the cyclone; a conical lower section and a cylindrical upper section, wherein the conical lower section incorporates the rotating cyclone body;
a first cleaning assembly which can be selectively operated to clean an inner surface of the cylindrical upper section;
a second cleaning assembly which can be selectively operated to clean an outer surface of the sleeve of the vortex finder.

Preferably the first cleaning assembly and the second cleaning assembly are combined such that upon activation of the combined cleaning assembly the inner surface of the cylindrical upper section and the outer surface of the surface of the vortex finder are cleaned simultaneously.

The vortex finder may comprise a fines recovery apparatus wherein at least a portion of fine particulate material entrained in the gas stream is recovered and recirculated into the cyclone body.

The cyclone may comprise a third cleaning assembly wherein a cleaning fluid, such as water, is injected into the cyclone to clean one or more inner surfaces thereof. The third cleaning assembly may comprise a plurality of nozzles located in the lid of the cyclone.

The cyclone may be a reverse flow cyclone.

### BRIEF DESCRIPTION OF THE DRAWINGS

Further features of the present invention are more fully described in the following description of a non-limiting embodiment thereof. This description is included solely for the purposes of exemplifying the present invention. It should not be understood as a restriction on the broad summary, disclosure or description of the invention as set out herein. The description will be made with reference to the accompanying drawings in which:

FIG. 1 is a perspective view of a sampling apparatus having a cyclone according to a first embodiment of the present invention;

FIG. 2 is a front view of FIG. 1;

FIG. 3 is a side view of the cyclone shown in FIG. 1;

FIG. 4 is a cross sectional side view of the cyclone through line AA shown in FIG. 3;

FIG. 5 is an alternate side view of the cyclone shown in FIG. 1;

FIG. 6 is a cross sectional side view of the cyclone through line BB shown in FIG. 5;

FIG. 7 is a close up sectional side view of detail C shown in FIG. 6;

FIG. 8 is a close up sectional side view of detail D shown in FIG. 6;

FIG. 9 is a perspective view of a cyclone according to a second embodiment of the present invention;

FIG. 10 is a perspective view of a cylindrical upper section of the cyclone shown in FIG. 9 from a different angle;

FIG. 11 is a side view of the cylindrical upper section of the cyclone shown in FIG. 10;

FIG. 12 is a cross sectional side perspective view of the cylindrical upper section of the cyclone shown in FIG. 10;

FIG. 13 is a bottom view of the cylindrical upper section of the cyclone shown in FIG. 10;

FIG. 14 is a perspective view of a cleaning scraper;

FIG. 15 is a side view of the cyclone shown in FIG. 9;

FIG. 16 is a cross sectional side view of the cyclone through line EE shown in FIG. 15;

FIG. 17 is an alternate side view of the cyclone shown in FIG. 9;

FIG. 18 is a cross sectional side view of the cyclone through line FF shown in FIG. 17;

FIG. 19 is a close up sectional side view of detail G shown in FIG. 18;

FIG. 20 is a close up sectional side view of detail H shown in FIG. 18;

FIG. 21 is a view of a similar detail as FIG. 19 angularly/rotationally spaced about the housing therefrom;

FIG. 22 is a view of a similar detail as FIG. 19 angularly/rotationally spaced about the housing therefrom;

FIG. 23 is a cross sectional side view of a cyclone according to a third embodiment of the present invention, the cyclone comprising a fines recovery apparatus;

FIG. 24 is a cross sectional side view of an upper section of the cyclone shown in FIG. 23;

FIG. 25 is a bottom perspective view of the fines recovery apparatus shown in FIG. 23;

FIG. 26 is a cross sectional side view of the fines recovery apparatus shown in FIG. 25; and

FIG. 27 is an exploded view of the fines recovery apparatus shown in FIG. 25.

In the drawings like structures are referred to by like numerals throughout the several views. The drawings shown are not necessarily to scale, with emphasis instead generally being placed upon illustrating the principles of the present invention.

### DETAILED DESCRIPTION OF THE PREFERRED EMBODIMENTS

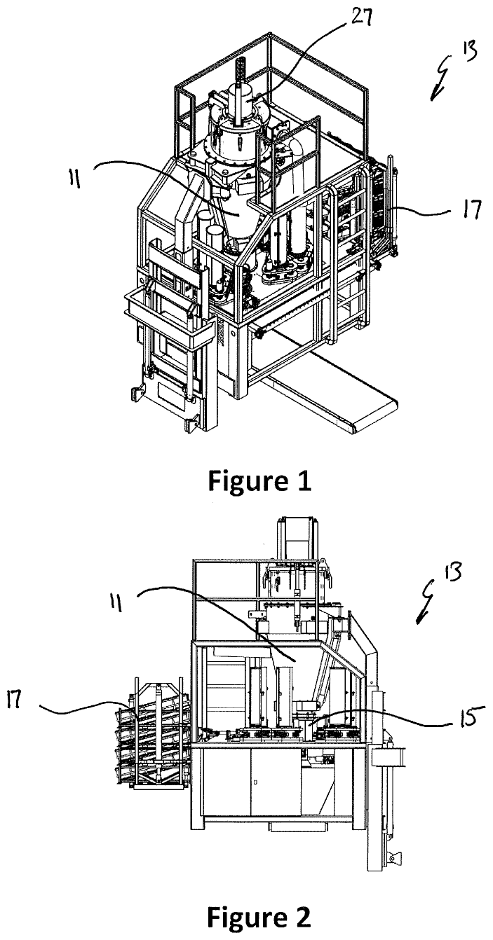

Referring to FIGS. 1 and 2, the invention according to the first embodiment is in the form of a cyclone 11 used in a sampling apparatus 13. The sampling apparatus 13 receives cuttings entrained in a gaseous stream from a drill rig (not shown), passes it through the cyclone 11 to separate the cuttings from the gaseous stream, before taking samples from the cuttings for analysis. In the present application the sampling apparatus 13 also comprises a splitter assembly 15 and a sampling assembly 17.

The splitter assembly 15 receives the cuttings from the cyclone 11. These cuttings are mixed in the splitter assembly 15 to aid in ensuring the sample is as fair a representation of the drilled cuttings as possible, eliminating bias which may be induced by the cyclone 11, the drilling process and/or the manner in which the dirty gaseous stream is delivered to the sampling apparatus 13.

The sampling apparatus 13 is adapted to be releasably secured to a drill rig (not shown). While the present sampling apparatus 13 is particularly designed to operate autonomously, such as on an autonomous drilling rig, it can also be readily integrated into existing drill rigs, and may be set up for manual or autonomous operation.

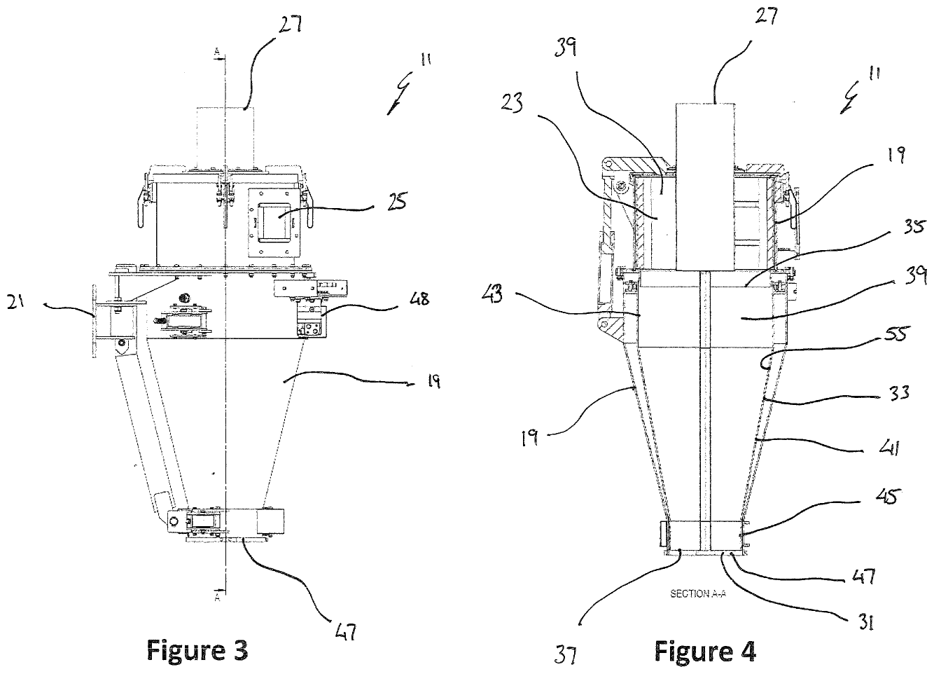

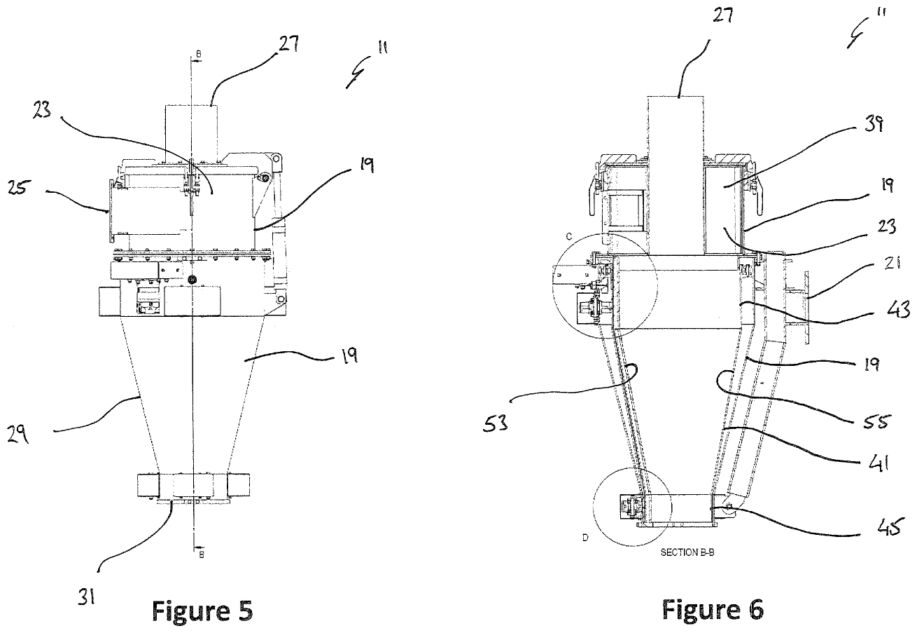

Referring to FIGS. 3 to 8, the cyclone 11 comprises a housing 19 which can be secured to the drill rig using a bracket 21. The housing 19 has a cylindrical upper section 23 which provides an inlet 25 through which a dirty gaseous stream enters the cyclone 11. The cylindrical upper section 23 also supports a vent 27, commonly referred to as a vortex finder, for venting a gaseous stream once cuttings are removed therefrom.

The housing 19 also has a conical lower section 29 which has a housing outlet 31 and incorporates a cyclone body 33.

As shown in FIG. 4, the cyclone body 33 is rotatably supported in the housing 19. The cyclone body 33 is rotatably supported at a first end 35 and at a second end 37, the first end 35 having a larger diameter than the second end 37. The first end 35 is in fluid communication with the inlet 25 through which the dirty gaseous stream enters the cyclone 11.

The cyclone body 33 incorporates a conical lower section 41 located between a first sleeve section 43 and a second sleeve section 45, as best shown in FIG. 6. The first sleeve section 43 provides the first end 35, and the second sleeve section 45 provides the second end 37.

The cylindrical upper section 23 of the housing 19 co-operates with the cyclone body 33 to define a separator region 39 in which the dirty gaseous stream is received.

The separator region 39 incorporates the inlet 25 for receiving the dirty gaseous stream, an outlet 47 through which the cuttings exit the separator region 39 and the cyclone 11, and the vent 27 through which the gaseous stream exits the separator region 39 and the cyclone 11. With the exception of the inlet 25, outlet 47 and vent 27 the separator region 39 is relatively sealed to minimize leakage from the cyclone 11.

The cyclone 11 incorporates a drive and support means 48, in the form of a motor and rollers. The drive and support means 48 rotates the cyclone body 33, and in particular the first sleeve section 43, relative to the housing 19.

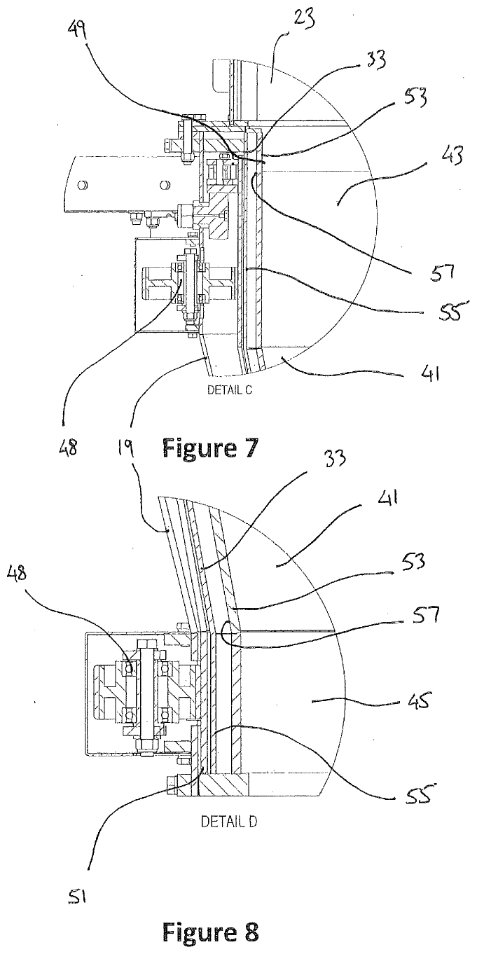

As best shown in FIGS. 7 and 8, a first seal arrangement 49 seals the region between the first end 35 of the cyclone body 33 and the housing 19, and a second seal arrangement 51 seals the region between the second end 37 of the cyclone body 33 and the housing 19. The first seal arrangement 49 and the second seal arrangement 51 assist in sealing the separator region 39 to minimize any leakage from the cyclone 11.

The second end 37 of the cyclone body 33 has an outlet therein which also provides the outlet 47 of the separator region 39 and the cyclone 11.

The cyclone 11 incorporates at least one cleaning element, in the form of a scraper 53. The scraper 53 is fixed relative to an inner surface 55 of the cyclone body 33. As best shown in FIGS. 7 and 8 the scraper 53 has an edge 57 which is adjacent the inner surface 55 of the cyclone body 33. The edge 57 is sufficiently spaced from the inner surface 55 to allow the cyclone body 33 to freely rotate, while being sufficiently close to remove any excessive buildup on the inner surface 55 as the cyclone body 33 rotates.

In the present embodiment the scraper 53 is in the form of a flat elongate element angled such that it follows the contours of the inner surface 55 of the cyclone body 33.

In operation the dirty gaseous stream from drilling enters the separator region 39 through the inlet 25. The rotating conical body 33 acts in the same manner as a traditional cyclone in that the cuttings are caused to fall to the bottom of the cyclone body 33 while the gaseous stream exits the cyclone 11 through the vent 27. Unlike traditional cyclones, the cylinder body 33 rotates and the inner surface of the cyclone body is kept clean by the action of the scraper 53 as the cylinder body 33 rotates. This effectively prevents buildup of the material through caking, and prevents the cyclone 11 from clogging, both conditions which are particularly problematic when wet cuttings are encountered. As a result the need for personnel to regularly clean and de-clog the cyclone 11 is eliminated.

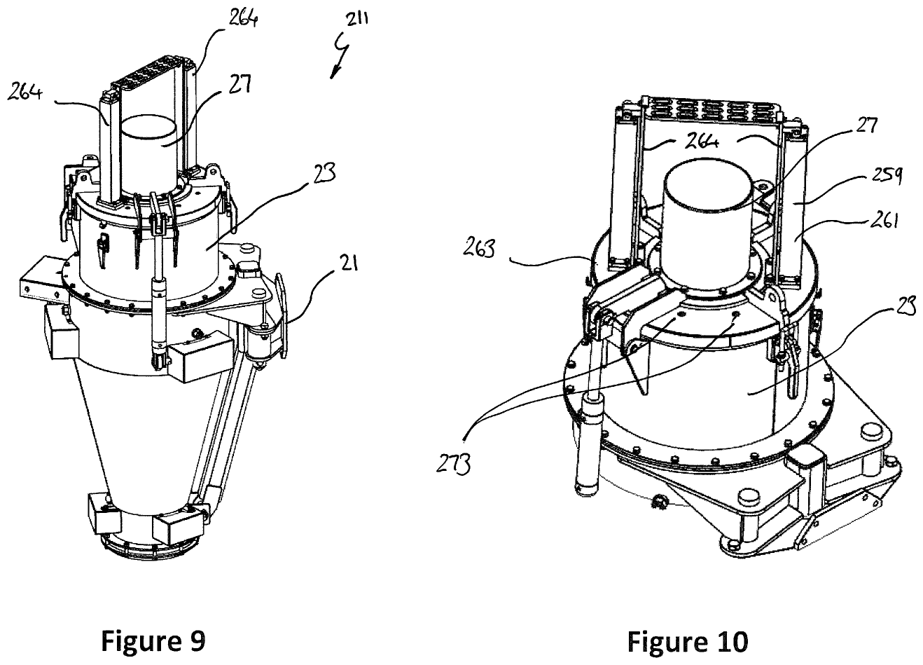

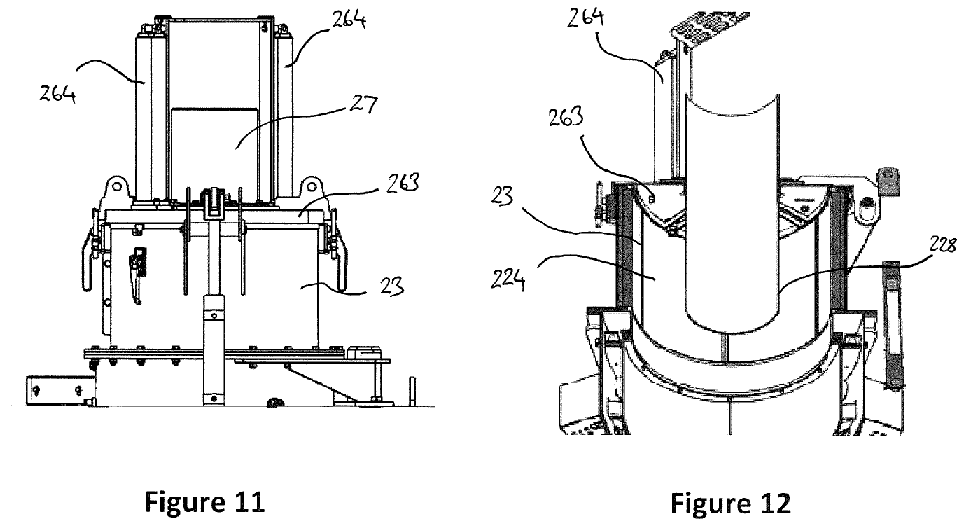

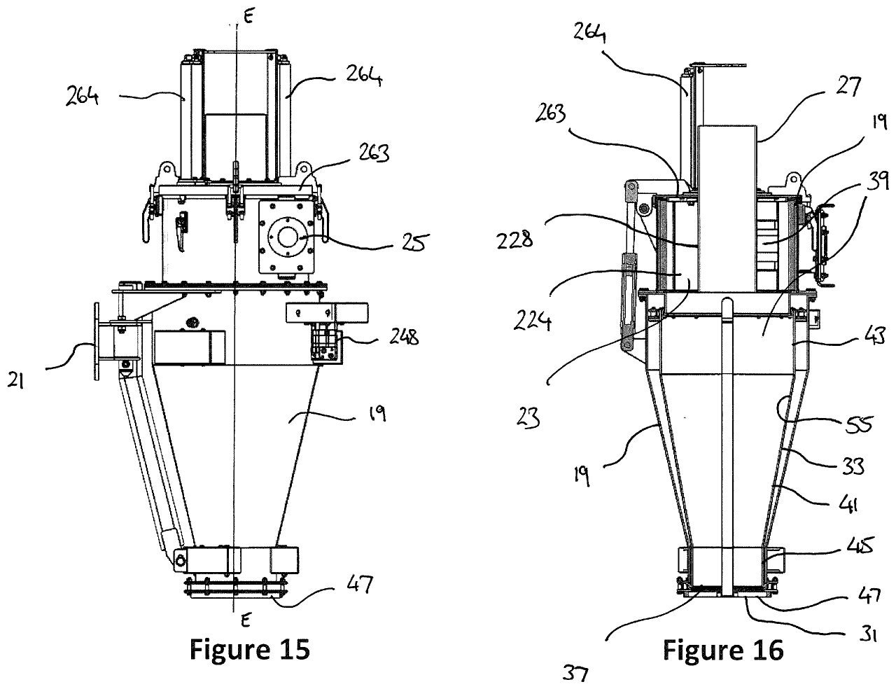

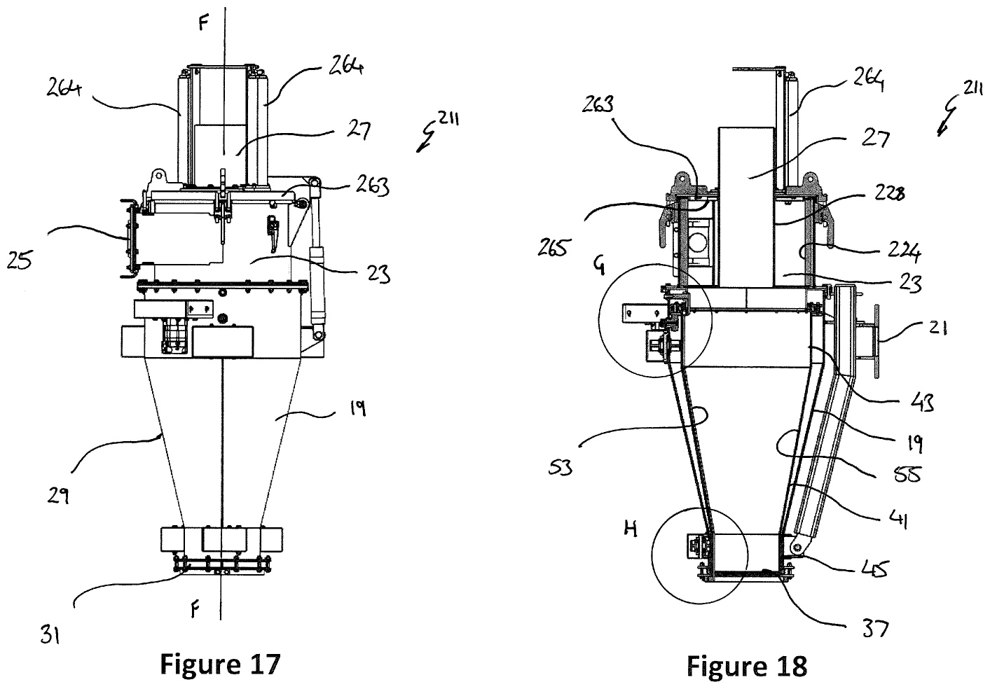

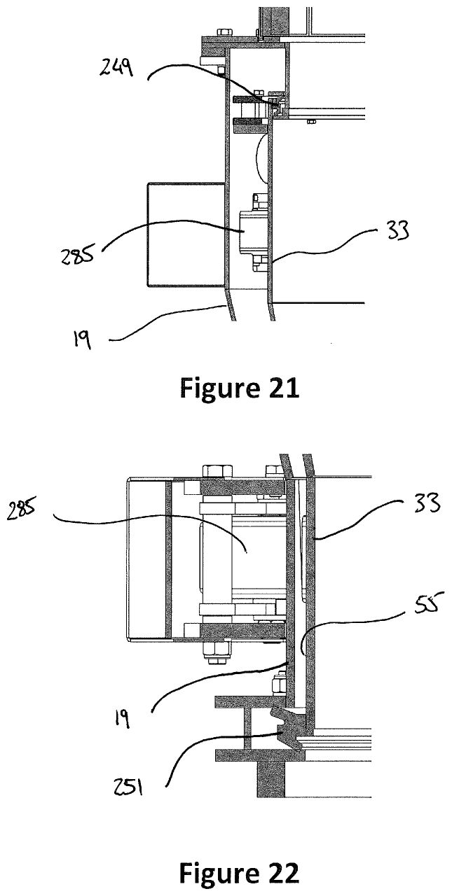

A cyclone 211 according to a second embodiment of the invention is illustrated in FIGS. 9 to 22. For convenience features of the cyclone 211 that are similar or correspond to features of the cyclone 11 of the first embodiment have been referenced with the same reference numerals.

In this embodiment the cyclone 211 further comprises a means to clean an internal inner surface 224 of a cylindrical upper section 23 and an internal outer surface 228 of the vent 27. In particular the cyclone comprises a first cleaning assembly 259 which can be selectively operated to clean the inner surface 224 of the cylindrical upper section 23 and a second cleaning assembly 261 which can be selectively operated to clean an outer surface 228 of the vent 27. In this embodiment the first cleaning assembly 259 and the second cleaning assembly 261 are combined such that upon activation of the combined cleaning assembly 259, 261 the inner surface 224 of the cylindrical upper section 23 and the outer surface 228 of the vent 27 are cleaned simultaneously.

The combined cleaning assembly 259, 261 is supported by a lid 263 of the cyclone 211 and is pneumatically operated. As would be readily understood by the person skilled in the art, the combined cleaning assembly can be operated by other known means such as by hydraulics or electricity.

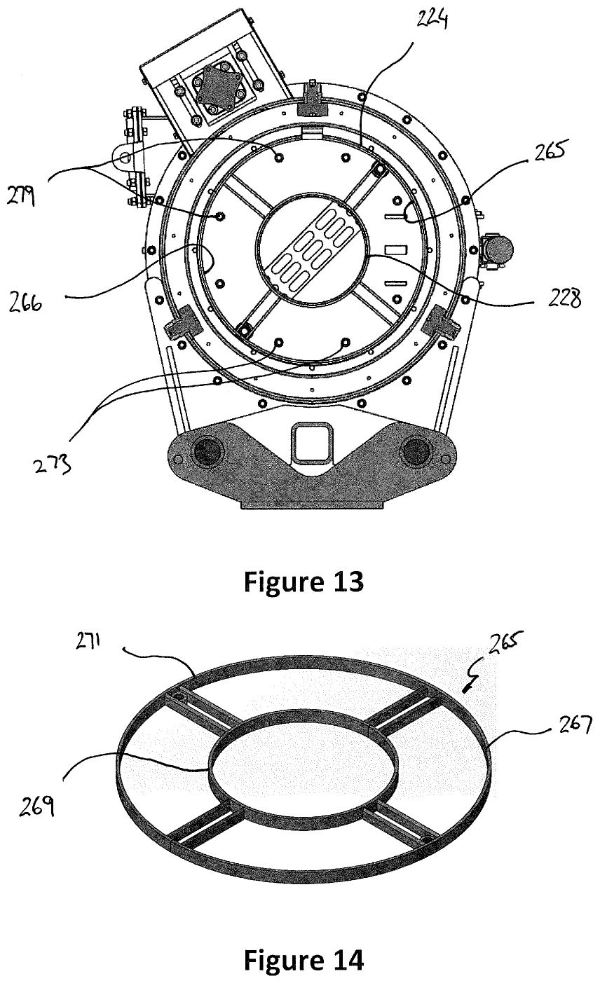

The combined cleaning assembly 259, 261 comprises a set of cylinders 264 mounted on an external surface of the lid 263 and operatively connected to a circular cutter 265, which is housed in a recess 266 on the underside of the lid 263, as best shown in FIG. 13. Referring to FIG. 14, the circular cutter 265 has a first annular blade 267 and a smaller second annular blade 269.

An upper edge 271 of the circular cutter 265 is chamfered such that there is minimal buildup thereon which could otherwise prevent the circular cutter 265 returning to the recess 266.

Upon activation of the combined cleaning assembly 259, 261 the circular cutter 265 is caused to travel away from the lid 263. The circular cutter 265 is sized such that the first annular cutter 267 travels in close proximity to the inner surface 224 of the cylindrical upper section 23, removing any build up thereon. In addition the circular cutter 265 is sized such that the second annular cutter 269 travels in close proximity to the outer surface 228 of the vent 27, removing any build up thereon.

Upon activation of the combined cleaning assembly 259, 261 buildup is simultaneously removed from the inner surface 224 of the cylindrical upper section 23 and the outer surface 228 of the vent 27.

In this embodiment the cyclone also comprises a third cleaning assembly 273. The third cleaning assembly 273 comprises a plurality of nozzles 279 housed in the lid 263 of the cyclone 211. A pressurized cleaning fluid, such as water, is injected into the cyclone 211 through the plurality of nozzles 279 to clean one or more inner surfaces thereof.

When the circular cutter 265 of the combined cleaning assembly 259, 261 is housed in the recess 266 the circular cutter 265 does not interfere with the spray ejected from the nozzles 279.

A further difference between the cyclone 211 of the second embodiment and the cyclone 11 of the first embodiment is the seal arrangement.

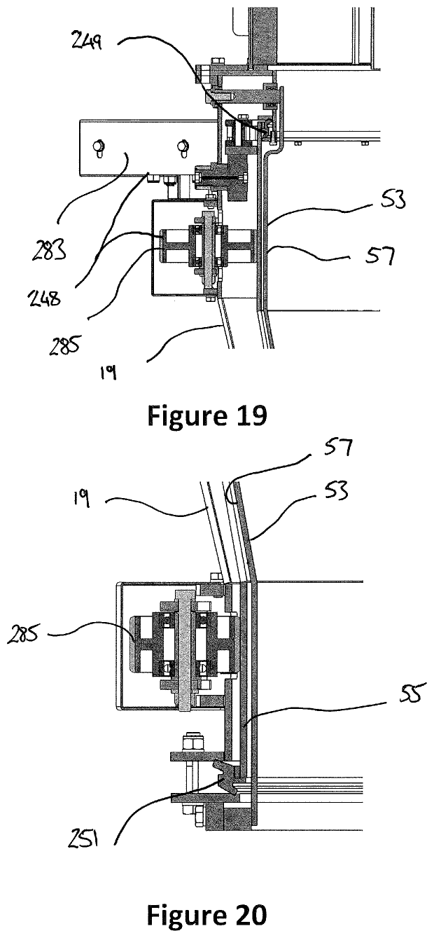

As best shown in FIGS. 19 to 22, the cyclone 211 comprises a first drum seal 249 which seals the region between the first end 35 of the cyclone body 33 and the housing 19, and a second drum seal 251 which seals the region between the second end 37 of the cyclone body 33 and the housing 19. The first drum seal 249 and the second drum seal 251 assist in sealing the separator region 39 to minimize any leakage from the cyclone 11. This arrangement also enables maintenance of the cyclone body 33 and its associated components without having to completely disassemble the cyclone 211.

The cyclone 211 also incorporates a drive and support means 248, in the form of a motor 283 and a plurality of rollers 285. The drive and support means 48 rotates the cyclone body 33, and in particular drives the first sleeve section 43, relative to the housing 19. In other embodiments the rollers may be or may include axial support rollers.

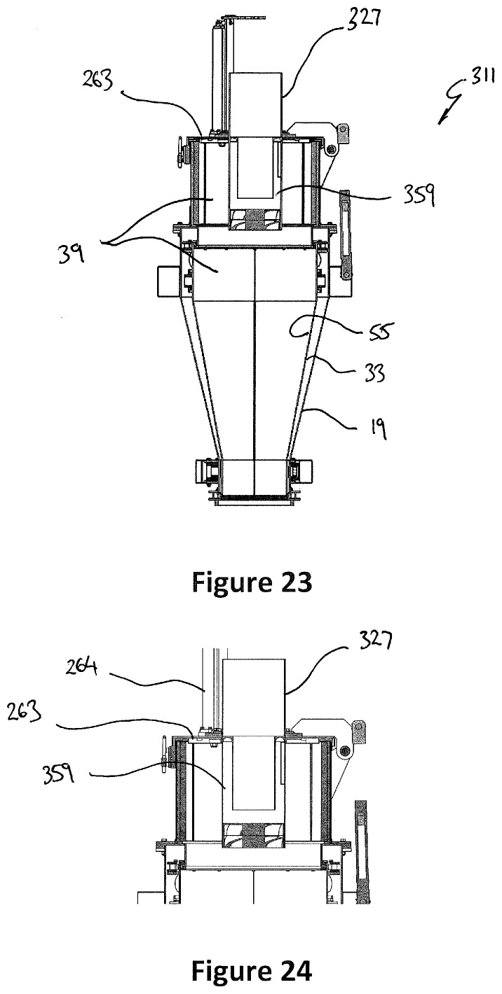

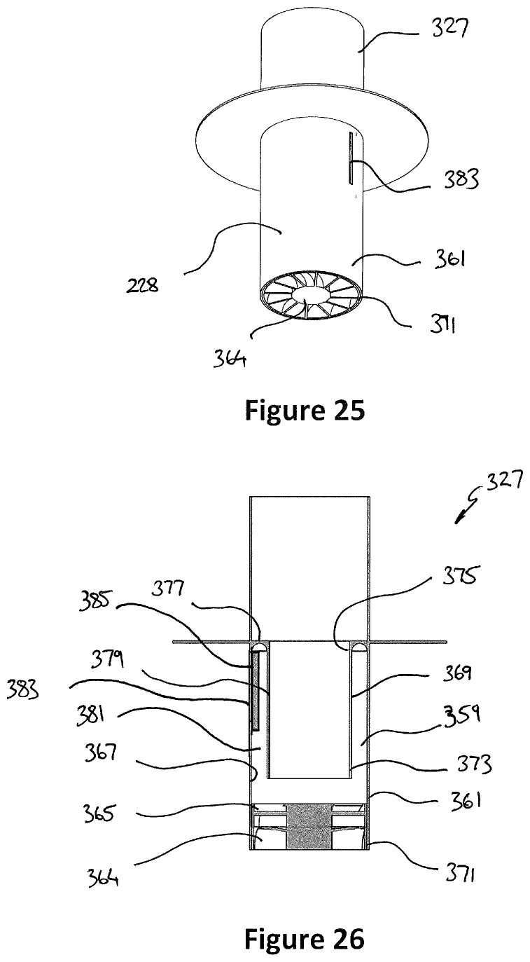

A cyclone 311 according to a third embodiment of the invention is illustrated in FIGS. 23 to 27. For convenience features of the cyclone 211 that are similar or correspond to features of the cyclone 11 of the first embodiment and features of the cyclone 211 of the second embodiment have been referenced with the same reference numerals.

In this embodiment the cyclone 311 further comprises a means to redirect finer particulates in the gaseous stream from the vent 327 to the separator region 39. In this embodiment the vent 327 comprises a fines recovery apparatus 359 wherein at least a portion of fine particulate material entrained in the gaseous stream is recovered and recirculated into the separator region 39 rather than being discharged from the cyclone 311 through the vent 327.

The fines recovery apparatus 359 is incorporated in a first end portion 361 of the vent 327, the first end portion 361 being located adjacent the cyclone body 33 inward from the underside of the lid 263.

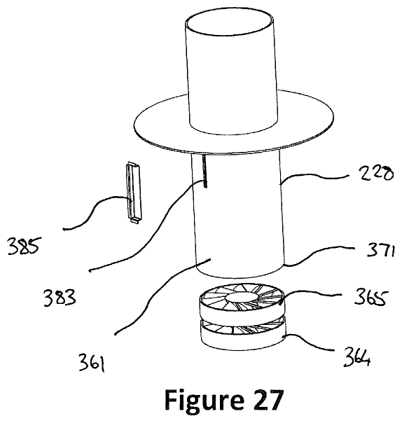

The fines recovery apparatus 359 provides a deflector assembly comprising a first deflector 364 and a second deflector 365 mounted in series, as best shown in FIGS. 26 and 27. Each of the first defector 364 and the second deflector 365 comprise a set of turbine blades, wherein those of the first deflector 364 are staggered relative to the set of turbine blades of the second deflector 365. Upon entering the fines recovery apparatus 359 the gaseous stream is deflected towards an inner surface 367 of the fines recovery apparatus 359.

The fines recovery apparatus 359 comprises an inner sleeve 369 co-axially mounted inward of a first end 371 of the vent 327. The inner sleeve 369 has a smaller outer diameter than the inner diameter of the vent 327, wherein a first end 373 of the inner sleeve 369 is inwardly spaced from the deflector assembly, as best shown in FIG. 26.

A second end 375 of the inner sleeve 369 has an outwardly projecting flange 377 extending between the sleeve 369 and the inner wall of the vent 327, such that an outer surface 379 of the inner sleeve 369, the inner surface 367 of the first end portion of the vent 327, and the flange 377 co-operate to define an annular sleeve 381 having an open end and a closed end, wherein the open end allows the fine particulate material to enter the annular sleeve 381.

The vent 327 also incorporates a port 383 extending through the wall of the vent 327 wherein the port 383 opens into the annular sleeve 381 allowing the fine particulate material to exit the annular sleeve 381 and re-enter the separator region 39.

The fines recovery apparatus 359 also comprises a hood 385 secured to the inner surface of the vent 327 adjacent the port 383, wherein the hood 385 collects and directs the fine particulate material from the annular sleeve 381 through the port 383.

The fines recovery apparatus deflects the gas stream leaving the cyclone body to swirl around the first end portion of the vent, engaging with the inner surface thereof and exiting through the exit port to return to the cyclone body. This minimizes the volume of the sample which may escape the cyclone through the vent, leading to a more accurate representation of the sample.

In contrast to prior art, the present invention enables cleaning of the cyclone which minimizes material build up, caking and the likelihood of clogging and contamination of the collected sample. A problem with the prior art cyclones is build-up/caking which can occur on the surface. This is caused by variations in the cuttings, such as the moisture content particularly when cuttings alternate from dry to wet to dry. This creates an environment for the cuttings to stick to the walls of the cyclone and any other surfaces. This is also caused with changes in the type of material being drilled which can vary in clay content, which are particularly sticky on surfaces. In the current invention the surfaces of the cyclone are cleaned to minimize the likelihood of buildup/caking. By minimising build up/caking the likelihood of clogging and contamination of collected samples is also minimized.

Modifications and variations such as would be apparent to the skilled addressee are considered to fall within the scope of the present invention. The present invention is not to be limited in scope by any of the specific embodiments described herein. These embodiments are intended for the purpose of exemplification only. Functionally equivalent products, formulations and methods are clearly within the scope of the invention as described herein. It will be understood by those skilled in the art that various changes in form and details may be made therein without departing from the spirit and scope of the invention as defined by the appended claims.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

Such variations are not to be regarded as a departure from the disclosure, and all such modifications are intended to be included within the scope of the disclosure.

Reference to positional descriptions and spatially relative terms), such as “inner,” “outer,” “beneath”, “below”, “lower”, “above”, “upper” and the like, are to be taken in context of the embodiments depicted in the figures, and are not to be taken as limiting the invention to the literal interpretation of the term but rather as would be understood by the skilled addressee.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

It will be understood that when an element is referred to as being “on”, “engaged”, “connected” or “coupled” to another element/layer, it may be directly on, engaged, connected or coupled to the other element/layer or intervening elements/layers may be present. Other words used to describe the relationship between elements/layers should be interpreted in a like fashion (e.g., “between”, “adjacent”). As used herein the term “and/or” includes any and all combinations of one or more of the associated listed items.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprise”, “comprises,” “comprising,” “including,” and “having,” or variations thereof are inclusive and therefore specify the presence of stated features, integers, steps, operations, elements, and/or components, but do not preclude the presence or addition of one or more other features, integers, steps, operations, elements, components, and/or groups thereof.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

1-62. (canceled)

63. A sampling apparatus for use in extracting a sample from cuttings which are delivered to the sampling apparatus entrained in a gaseous stream, the sampling apparatus comprises:
a separation means to separate the cuttings from the gaseous stream; and
a sampling assembly adapted to receive the cuttings from the separation means to allow samples to be taken therefrom,
wherein the separation means comprises:
a cyclone to which the cuttings entrained in the gaseous stream are delivered, the cyclone having an outlet through which the cuttings pass from the cyclone, and a vent through which the gaseous stream with a remaining portion of drilled material entrained therein passes, the cyclone comprising an inner rotating body, wherein the inner rotating body is cleaned as it rotates.

64. The sampling apparatus of claim 63, wherein an inner surface of the inner rotating body of the cyclone is cleaned as it rotates.

65. A sampling apparatus for use in extracting a sample from cuttings which are delivered to the sampling apparatus entrained in a gaseous stream, the sampling apparatus comprises:
a separation means to separate drilled material from the gaseous stream;
a splitter assembly to mix the cuttings, wherein the cuttings exit the separation means and pass into the splitter assembly; and
a sampling assembly adapted to receive the cuttings from the splitter assembly and cause samples to be taken therefrom,
the separation means comprises:
a cyclone to which the cuttings entrained in the gaseous stream are delivered, the cyclone having an outlet through which the cuttings pass from the cyclone, and a vent through which the gaseous stream can pass; and
the cyclone comprising an inner rotating body wherein an inner surface of the inner rotating body is cleaned as it rotates.

66. The sampling apparatus of claim 65, wherein the cyclone comprises a conical lower section and a cylindrical upper section, wherein the conical lower section incorporates the inner rotating body.

67. The sampling apparatus of claim 66, wherein the cyclone comprises a first cleaning assembly which is selectively operated to clean an inner surface of the cylindrical upper section.

68. The sampling apparatus of claim 67, wherein the vent is a vortex finder comprising a sleeve which extends into the cyclone through a lid of the cyclone.

69. The sampling apparatus of claim 68, wherein the cyclone comprises a second cleaning assembly which is selectively operated to clean an outer surface of the sleeve of the vortex finder.

70. The sampling apparatus of claim 69 wherein the cyclone comprises a third cleaning assembly for injecting a cleaning fluid into the cyclone to clean one or more of the inner surfaces thereof.

71. The sampling apparatus of claim 68, wherein the vortex finder comprises a fines recovery apparatus, wherein at least a portion of fine particulate material entrained in the gaseous stream is recovered and recirculated into the cyclone therein.

72. A cyclone for removing particulates from a gas stream, the cyclone comprises:
a housing which is adapted to receive a dirty gaseous stream; and
a cyclone body rotatably supported in the housing, wherein the dirty gaseous stream enters the cyclone body whereupon particulates are caused to fall to a bottom of the cyclone body and be discharged therefrom, while the gas stream is vented from the cyclone body.

73. The cyclone of claim 72, comprising a drive means to rotate the cyclone body relative to the housing, wherein a rotational velocity of the cyclone body is varied according to various parameters including: a drill penetration rate, a cycle rate where an inner surface of the cyclone body is cleaned at least once per interval, a type of drilled material and its consistency, water/moisture volume ratio in cuttings, hydraulic efficiency, vibration induction, and prevention of bias where specific speeds result in a discharge bias.

74. The cyclone of claim 72, comprising a first seal arrangement for sealing a region between a first end of the cyclone body and the housing and/or a second seal arrangement for sealing a region between a second end of the cyclone body and the housing.

75. The cyclone of claim 72, comprising at least one cleaning element which is fixed relative to an inner surface of the cyclone body.

76. The cyclone of claim 75, wherein the at least one cleaning element has an edge which is adjacent the inner surface of the cyclone body, wherein the edge of the at least one cleaning element is sufficiently spaced from the inner surface of the cyclone body such that the cyclone is free to rotate, while any material attached to the inner surface of the cyclone body is removed.

77. The cyclone of claim 75, wherein the at least one cleaning element complements a contour of the inner surface of the cyclone body, wherein the at least one cleaning element continuously cleans the inner surface of the cyclone body as it rotates.

78. A cyclone for removing particulates from a dirty gaseous stream and discharging a gas stream therefrom, the cyclone comprises:
a cyclone body to receive the dirty gaseous stream, wherein the dirty gaseous stream enters the cyclone body whereupon the particulates are caused to fall to a bottom of the cyclone body to be discharged therefrom, while the gas stream is vented from the cyclone body and the cyclone through a vortex finder which provides an outlet from the cyclone;
a conical lower section and a cylindrical upper section, wherein the conical lower section incorporates the cyclone body; and
a first cleaning assembly which can be selectively operated to clean an inner surface of the cylindrical upper section.

79. The cyclone of claim 78, comprising a second cleaning assembly which can be selectively operated to clean an outer surface of a sleeve of the vortex finder.

80. The cyclone of claim 78 further comprises:
a second cleaning assembly which can be selectively operated to clean an outer surface of a sleeve of the vortex finder.

81. The cyclone of claim 80, wherein the first cleaning assembly and the second cleaning assembly are combined such that upon activation of the combined cleaning assembly the inner surface of the cylindrical upper section and the outer surface of the sleeve of the vortex finder are cleaned simultaneously.

82. The cyclone of claim 80, wherein the vortex finder comprises a fines recovery apparatus wherein at least a portion of the particulates entrained in the gas stream is recovered and recirculated into the cyclone body.
